(19) United States
(12) Patent Application Publication
(10) Pub. No.: US 2004/0132439 A1
(43) Pub. Date: Jul. 8, 2004

(54) Remotely controllable wireless sex toy

(76) Inventors: Vic Tyagi, Montgomery, IL (US); Steve Farkas, Highland Park, IL (US)

Correspondence Address: FACTOR & LAKE, LTD, 1327 W. WASHINGTON BLVD., SUITE 5G/H, CHICAGO, IL, 60607, US

(21) Appl. No.: 10/336,231

(22) Filed: Jan. 3, 2003

(51) Int. Cl. H04M 3/00

(52) U.S. Cl. 455/419; 455/418

(57) ABSTRACT

A remotely controllable wireless sex toy system is disclosed as having a sex toy with at least one operative function, a receiver associated with the sex toy, the receiver being capable of receiving a wireless signal for directing the at least one operative function, a transmitter located remotely from the sex toy, and in operative communication with a first position on a computer network, the transmitter being capable of transmitting the wireless signal, and elements for controlling the wireless signal on a second position on the computer network. This system can beneficially be used with a method for tracking the operation of the device, which is also disclosed herein.

### BACKGROUND OF THE INVENTION

1. Field of the Invention

This invention relates generally to the field of adult entertainment, and specifically to adult toys that enable both personal and interactive participation over distances.

2. Background Art

The adult toy industry, worldwide, is one of the largest and most successful aspects of adult entertainment today. One particular aspect of that industry, namely the manufacture and sale of vibrators/dildos, provides a significant percentage of the sales revenue for adult toy producers. Sales of these devices top the multiples of millions annually, with manufacturers producing both the devices themselves as well as replacement parts and accessories all over the world.

Typically, vibrators/dildos have been manufactured in a variety of shapes, with the devices being capable of a variety of pleasurable functions and/or functionalities. As is suggested by the name, most vibrators/dildos are capable of vibrating and/or gyrating, while others may be capable of rotation, extension, as well as emitting an electric charge. These devices can come in a variety of shapes and sizes, and generally can be characterized as “sex toys.” As technology has developed further, sales of adult toys and sex toys in particular have also increased.

One particular advancement recently introduced into the adult toy industry is the remote control of sex toys. Current systems enable the remote control of a sex toy, such as women's undergarments having a vibrating function, or corded sex toys, from the same general vicinity as the sex toy itself. Specifically, depending upon the nature of the remote, whether it is a wireless remote or a corded one, the distance between the party holding the remote and the party utilizing the sex toy is limited. In fact, current systems are generally limited to same-room exchanges.

The adult entertainment industry has flourished in the online environment offered by the internet. Adult internet sites are constantly looking for innovative methods and apparatus that can bring additional adult thrill seekers together, to build community among those people, and to subsequently increase incremental revenue and customer loyalty. Similarly, the advent of the internet and video conferencing has enabled couples to maintain long-distance relationships with a high degree of communication and intimacy. Therefore, there is a need to extend the reach of current adult entertainment products beyond the same-room limitations of current technology.

It is therefore an object of this invention to provide an adult entertainment device that is capable of wireless operation where the controller may operate the device at a great distance.

It is also an object of this invention to provide a method of enabling the tracking of the usage of such a device.

These and other objects will become apparent to one of ordinary skill in the art given the specification, claims and drawings included herein.

### BRIEF DESCRIPTION OF THE DRAWINGS

FIG. 1 comprises a plan view of an interactive wireless sex toy system;

FIG. 2 comprises a front view of a software CD for use with such a system.

### SUMMARY OF THE INVENTION

The present invention is a remotely controllable wireless sex toy system that includes a sex toy having at least one operative function, a receiver associated with the sex toy, the receiver being capable of receiving a wireless signal for directing the at least one operative function, a transmitter located remotely from the sex toy, and in operative communication with a first position on a computer network, the transmitter being capable of transmitting the wireless signal, and elements for controlling the wireless signal on a second position on the computer network. Such a system, when combined, allows for the remote control of the functionalities of the sex toy from great distances, including controlling the vibration, rotation, elongation, gyration, pulsation, and the emission of a low-level electric charge from the sex toy.

In one preferred embodiment of the present system, the controlling elements include one or more devices for inputting a control command, and a software package for translating the control command into a corresponding change in the wireless signal. For example, the inputting device could be a keyboard, a joystick, etc.

In order to beneficially operate the device, and in a preferred embodiment, the receiver is either standard mounted or mounted as an attachment to the sex toy. The receiver is capable of receiving a wide variety of signal types, including RF signals, that are transmitted over a computer network to the transmitter, and then wirelessly to the sex toy.

The computer network can include any combination of two or more computers, such as a private network, or the World Wide Web.

Such a system can best be used in the present business environment if the usage of the system can be tracked. Therefore, the present invention additionally includes a method for enabling the tracked operation of an interactive wireless sex toy system. To track the usage, a company should undertake the steps of (1) providing an interactive software package having a unique identifier to a first party, (2) allowing the first party to install the interactive software package onto a computer capable of connecting to a computer network, (3) requiring the first party to connect the computer to a computer network having a second position at which the first party is located, and a first position at which a wireless interactive sex toy is located, (4) requiring the first party to enter the unique identifier into the computer, (5) requiring the first party to enter identification information, (6) sending the unique identifier and identification information to a predetermined location using the computer network, (7) authorizing usage of the interactive software package based on the sent information, and (8) enabling interactivity between the first party and the wireless interactive sex toy.

Through the use of the above method and system, a completely interactive wireless sex toy system can be achieved.

### DETAILED DESCRIPTION OF THE INVENTION

While this invention is susceptible of embodiment in many different forms, there is shown in the drawings and will be described in detail, several specific embodiments with the understanding that the present disclosure is to be considered as an exemplification of the principles of the invention and is not intended to limit the invention to the embodiments illustrated.

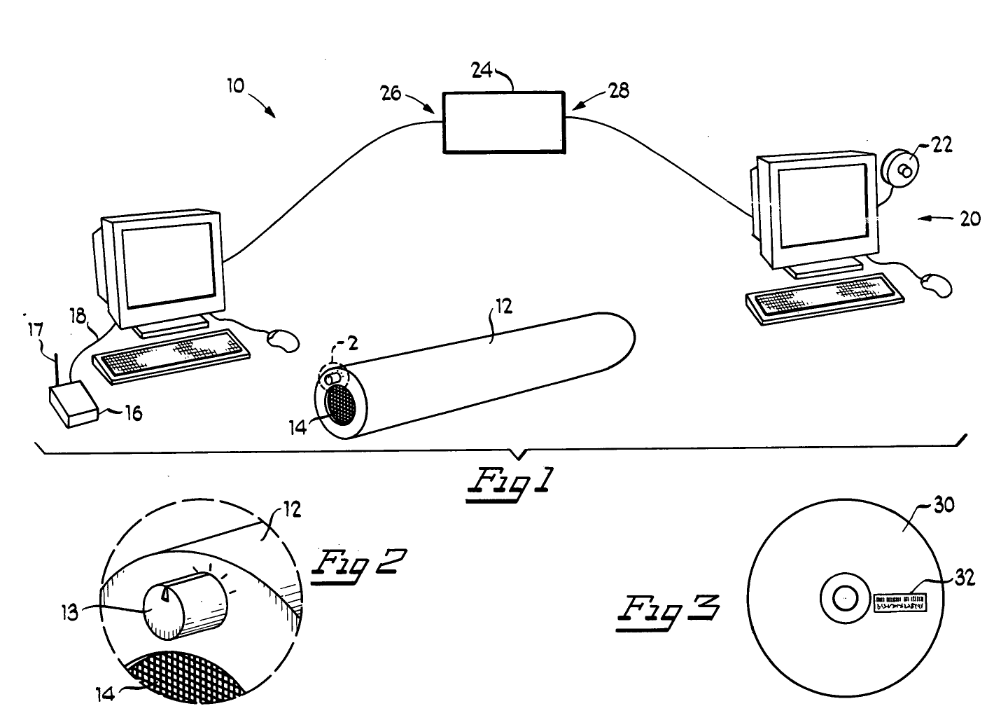

Interactive wireless sex toy system 10 is shown in FIG. 1 as comprising sex toy 12, receiver 14, transmitter 16, computer network 24, and means 20 for controlling the wireless signal. Together these elements enable the operation of at least one function of sex toy 12 from a remote location. To do so, sex toy 12 has receiver 14 associated therewith, which is capable of receiving a wireless signal from transmitter 16. Transmitter 16, in turn, is in operative communication with computer network 24 at first position 26. At another location on computer network 24, specifically at second position 28, is wireless signal controlling means 20. Wireless signal controlling means 20 enables a user located at second position 28 to control the functionality of sex toy 12 at first position 26, even at a distance.

Sex toy 12 can comprise any number of adult entertainment devices. For example, sex toy 12 could comprise a vibrator, dildo, massager, or similar device. In any case, sex toy 12 should have at least one operative functionality that can be altered, such as a vibrating function, a rotational function, an extending function, or the like. Such operational features are known in the art, and sex toy 12 of the present invention can incorporate any such functionality, as long as the activation of or degree of activation can be controlled. The operation of the functionality of sex toy 12 can be altered either manually using control dial 13, or remotely using receiver 14, as discussed below.

To help control the functionality of sex toy 12, wireless sex toy 10 additionally has receiver 14 associated therewith. Receiver 14 is capable of receiving a wireless signal from an external source, and communicating that signal to sex toy 12. The wireless signal may then alter the operational function of sex toy 12. To effectively retransmit the wireless signal from receiver 14 to sex toy 12, receiver 14 should be either mounted to sex toy 12 either as an attachment or integrated from the factory.

Receiver 14 receives the wireless signal from transmitter 16. Transmitter 16 is shown in FIG. 1 as comprising a rectangular box having an antenna 17, which is capable of transmitting any number of wireless signals. Preferably, transmitter 16 is a RF transmitter, but may additionally comprise Infra-red (IR), or by other electromagnetic means. Whatever the specific type of wireless signal, receiver 14 should be configured to properly receive the signal type selected, and then retransmit that signal to sex toy 12.

Transmitter 16 does not originate the wireless signal, however. Instead, transmitter 16 receives a control signal from over computer network 24 from controlling means 20, and then converts the control signal into the wireless signal. To receive the control signal from computer network 24, transmitter 16 includes connector 18 to connect it to computer network 24 at first position 26. Connector 18 can comprise a conventional means for connecting a device to computer networks, including serial cable, USB cable, FireWire cable, or other connector cable, or connected directly to computer via a system bus (PCI, VESA, etc.). Similarly, connector 18 could comprise a wireless networking connection, such as an 802.11b hub, or Bluetooth connection that is, in turn, connected to computer network 24. Such types of connections are well known in the art.

Computer network 24, which carries the control signal, preferably comprises a network of two or more computers. For example, computer network 24 could comprise a private network of computers consisting of as little as two computers, such as in a home network of computers. Alternatively, computer network 24 could comprise the World Wide Web, consisting of a multitude of inter-networked computers. Computer network 24 enables the control signal to be transmitted to transmitter 16 from control means 20, and then transmitted wirelessly to sex toy 12.

The control signal originates at second position 28 of computer network 24, at controlling means 20. Controlling means 20 preferably comprises a combination of computer software and an input apparatus, such as a keyboard of a computer. The input apparatus enables a user of the computer to direct the operation of sex toy 12 through the entry of commands at second position 28, which commands are then translated by the computer software into a control signal that is transmitted to transmitter 16. Such computer software is conventional and well known, and would be capable of appropriate programming by any one of ordinary skill in the art. It is the very nature of the input apparatus and software, however, which facilitates the effective operation of the system. The input software may include conventional software or virtual reality software that allows for the interaction of Virtual Avatars from said embodiment.

For example, in one preferred embodiment, the input apparatus comprises a keyboard, mouse, or other conventional input apparatus used in association with a computer, and the software comprises a combination of videoconferencing software and an instant messaging program, along with the necessary computer code to transmit any operational commands entered by the user. To further facilitate this particular embodiment, it is preferred that the computer includes web cam 22 or similar video device, such as a video camera. Such devices are typically connected to a computer via standard connecting cords, and enable the transmission of video and/or audio across the internet. Web cam 22 records video and/or audio signals from or near second position 28, while the instant messaging program enables the transmission of typed communications. The video and/or audio signals can be combined with the instant messenger program to provide several forms of communication and input, as may be needed.

In operation, a user at second position 28 of computer network 24 begins a communication session with a party at first position 26 on computer network 24. Alternatively, the party at first position 26 could initiate communication also. Once communications have been undertaken, the party at second position 28, using controlling means 20, can alter the functional operational parameters of sex toy 12. For example, if the party at first location 26 were presently operating sex toy 12 using the manual controls for the device, the party at second position 28 could alter the operating parameters, or magnitude of the functional operation. On the other hand, if operation of sex toy 12 has not yet begun, the user at second position 28 can begin operation of the device. In any case, controlling means 20 enables the user at second position 28 to alter the operational functionality of sex toy 12. In combination with the videoconferencing software and/or instant messaging software, or Virtual Reality software discussed above, the present invention provides a complete, interactive device for adult entertainment and interaction over a great distance.

The above described device can beneficially be utilized in certain adult entertainment venues currently existing on the internet. For example, such a system may beneficially be utilized with an online dating service, or with online sex shows, or online Virtual Reality software enabling the interactivity between consenting adults. To facilitate such a use, and as shown in FIG. 2, the present invention may include software CD 30 having unique identifier 32 thereon. Software CD 30 contains all of the necessary programming for a user located at second position 28 of computer network 24 to access the functionalities of sex toy 12 at first position 26. Further, unique identifier 32 provides a means for tracking the time and/or frequency of use of the system by a user. Together, these elements can provide a positive revenue stream for online service providers.

A number of different types of unique identifiers 32 can be utilized with the present system. For example, unique identifier 32 can comprise a serial number, or other unique numeric identification. Preferably, unique identifier 32 is correlated with the content of software CD 30 so that, after sale of the software CD has taken place, unique identifier 32 and software CD will always correlate to one another. Of course, other conventional forms of unique identifiers 32 can be used with the present system as well.

For example, one method by which these elements can be effectively utilized would be by: (1) providing an interactive software package having a unique identifier to a first party; (2) allowing the first party to install the interactive software package onto a computer capable of connecting to a computer network; (3) requiring the first party to connect the computer to a computer network having a second position at which the first party is located, and a first position at which a wireless interactive sex toy is located; (4) requiring the first party to enter the unique identifier into the computer; (5) requiring the first party to enter identification information; (6) sending the unique identifier and identification information to a predetermined location using the computer network; (7) authorizing usage of the interactive software package based on the sent information; and, thereafter, (8) enabling interactivity between the first party and the wireless interactive sex toy. Through this process, an internet hosting company can enable access to outside users to allow them access to the interactive wireless sex toy system, while tracking their usage and charging them accordingly. This system can therefore provide a beneficial and advantageous business opportunity to any online adult services proprietor.

The foregoing description merely explains and illustrates the invention and the invention is not limited thereto except insofar as the appended claims are so limited, as those skilled in the art that have the disclosure before them will be able to make modifications without departing from the scope of the invention.

What is claim is:

1. A remotely controllable wireless sex toy system, comprising:
a sex toy having at least one operative function;
a receiver associated with the sex toy, the receiver being capable of receiving a wireless signal for directing the at least one operative function;
a transmitter located remotely from the sex toy, and in operative communication with a first position on a computer network, the transmitter being capable of transmitting the wireless signal; and
means for controlling the wireless signal on a second position on the computer network.

2. The system according to claim 1, wherein the controlling means comprises means for inputting a control command, and a software package for translating the control command into a corresponding change in the wireless signal.

3. The system according to claim 2, wherein the inputting means comprises at least one of a keyboard, joystick, mouse, or other input device

4. The system according to claim 1, wherein the receiver is standard mounted to the sex toy.

5. The system according to claim 1, wherein the receiver is mounted to the sex toy.

6. The system according to claim 1, wherein the at least one operative function comprises at least one of vibration, rotation, elongation, gyration, pulsation, and the emission of a low-level electric charge.

7. The system according to claim 1, wherein the wireless signal comprises an RF signal, or a signal in any electromagnetic spectrum.

8. The system according to claim 1, wherein the computer network comprises a private network.

9. The system according to claim 1, wherein the computer network comprises the World Wide Web.

10. A method for enabling the tracked operation of an interactive wireless sex toy system, comprising the steps of:
providing an interactive software package having a unique identifier to a first party;
allowing the first party to install the interactive software package onto a computer capable of connecting to a computer network;
requiring the first party to connect the computer to a computer network having a second position at which the first party is located, and a first position at which a wireless interactive sex toy is located;
requiring the first party to enter the unique identifier into the computer;
requiring the first party to enter identification information;
sending the unique identifier and identification information to a predetermined location using the computer network;
authorizing usage of the interactive software package based on the sent information; and,
enabling interactivity between the first party and the wireless interactive sex toy.
